(19) United States
(12) Patent Application Publication
(10) Pub. No.: US 2006/0054668 A1
(43) Pub. Date: Mar. 16, 2006

(54) Dual additive soldering

(76) Inventor: Erik J. Severin, Pasadena, CA (US)

Correspondence Address: CHRISTIE, PARKER & HALE, LLP, PO BOX 7068, PASADENA, CA, 91109-7068, US

(21) Appl. No.: 11/227,863

(22) Filed: Sep. 14, 2005

Related U.S. Application Data
(60) Provisional application No. 60/609,589, filed on Sep. 14, 2004.

(51) Int. Cl. B23K 31/02; B23K 35/12

(52) U.S. Cl. 228/260

(57) ABSTRACT

Soldering with lead-free alloys is enhanced by use of two additives to a molten solder bath. One additive is an oxygen barrier fluid that floats on or envelops a bath. Another additive is an oxygen or metal oxide scavenger in the bath. Exemplary scavengers include metals with a higher free energy of oxide formation than oxide of tin, reducing gas, or an electrode immersed in the bath. The oxygen barrier may be an organic liquid, preferably polar in nature, which forms at least a monomolecular film over static surfaces of the bath. An exemplary soldering process is wave soldering of printed circuit boards.

### CROSS-REFERENCE TO RELATED APPLICATIONS

This U.S. patent application claims the priority benefit of U.S. provisional application No. 60/609,589, filed Sep. 14, 2004.

### BACKGROUND

Electronic components are commonly soldered to printed circuit (PC) boards with a lead-tin solder. A maximum soldering temperature of 260° C. (500° F.) has become a standard in the industry and this limit has propagated to many other parameters. For example, most components to be soldered to printed circuit boards are rated for a maximum temperature of 260° C. (500° F.). Continuous soldering apparatus is built to operate at a maximum temperature of about 260° C. Even the printed circuit (PC) boards (sometimes called printed wiring boards, PWB) are generally constructed for a maximum soldering temperature of about 260° C.

There is a desire to eliminate hazardous lead from solder, and there are even moves afoot to ban the use of lead. Exemplary substitute lead-free solder alloys include tin-silver and tin-silver-copper alloys having about 95-96.5% tin and 3.5-5% silver. Exemplary tin-silver base solder alloys sometimes have added alloying elements such as zinc, bismuth, antimony, germanium and/or indium. Pure tin with only enough additives to avoid growth of “tin whiskers” may also be used. There has been difficulty in implementing some of such alloys because the temperatures required for reliable solder joints has exceeded 260° C. Thus, there is a need for tin-silver alloy solder that can be used at temperatures no more than 260° C.

Soldering processes have been developed which make automatic soldering of PC boards highly reliable. Plated-through holes are filled, ample solder fillets are almost always found, and bridging between closely spaced connector points is rare. To achieve similar reliability with tin-silver solder alloys, it is generally found that soldering temperatures of 270 to 275° C. (525° F.) are necessary. Clearly this is higher than the conventional 260° C. limit, and reducing the soldering temperature with such lead-free substitute alloys is highly desirable.

Another issue which is of concern with respect to both the lead-tin solders and substitute solder alloys is accumulations of dross on the molten solder. Dross is an accumulation of oxides of the metals in the solder. It can form a solid crust on the molten solder as it accumulates during operation of soldering apparatus. Sometimes it is appropriate to shut down continuous operating apparatus and manually ladle dross from the solder bath. Even when not shut down, manual removal of dross from the surface of the hot solder is practiced. Substantial amounts of solder can be lost into the dross, which then needs to be processed to recover and recycle the metal. Even when dross is not visible, a small amount on the surface of the molten solder can lead to bridging of solder between closely spaced leads and/or failure to wet surfaces to be soldered, so that incomplete or poor joints are obtained.

This invention is useful in “wave soldering” apparatus which is conventional. Such apparatus comprises a large vat or “solder pot” in which several hundred pounds of solder may be held at the desired soldering temperature. A pump draws solder from near the bottom of this molten mass and forces it upwardly through one or more passages. A major portion of the solder then overflows in a “waterfall”. The upper surface of the flowing solder is commonly referred to as a “wave”. Another smaller portion of the solder overflows a weir (commonly referred to as a dross wing) into a secondary reservoir (commonly referred to as a dross chute). Molten solder returns from the reservoir to the larger solder pot. Dross forming on the solder due to oxidation upon exposure to air also overflows the weir and accumulates in the secondary reservoir, from which it may be removed. Some dross also may flow along the surface of the wave.

Exemplary wave soldering, fountain soldering and cascade soldering systems are described and illustrated in ASM Handbook, Volume 6, Welding, Brazing, and Soldering.

When the wave soldering apparatus is used for soldering, a printed circuit board is moved across the apparatus so that the lower face of the PC board contacts the upper surface of the wave of molten solder. The circuit components are mounted on the upper surface of the PC board with electrical leads extending into plated-through holes in the PC board. Molten solder wets the surfaces to be soldered, including the plated-through holes and leads, and makes good solder joints therebetween. It will be recognized that such a wave soldering apparatus is merely exemplary of any such apparatus and other variations are known in commercially available wave soldering machines.

The invention is also useful for pre-tinning PC boards or component leads and other soldering processes. For example, PC boards have conductive areas coated with solder by contact of the board with molten solder, somewhat the same way as in a wave solder apparatus, or boards may be dipped into a bath of molten solder. A blast of hot air is then used to blow away excess solder on contact pads and even from plated-through holes. The technique for preparing PC boards is called Hot Air Solder Leveling (HASL).

Although particularly interesting for lead-free tin-base solders, the invention is also useful with tin-lead and other conventional solders.

In practice of this invention, a fluid layer is maintained on the molten solder bath during the soldering process to act as an oxygen barrier. When the layer is liquid, at least a monolayer of a film-forming substance is desirable. One example of such a film-forming liquid layer is a heavy metal fatty acid soap. Other examples are mentioned hereinafter. Some oxygen barrier liquids may not be good film-formers. Secondly, an oxygen scavenger is used to reduce tin and other metal oxides. An example of such an additive is a rare earth metal or mixture of rare earth metals.

It is believed that dimer acids, silicone oils and high temperature-stable hydrocarbon oils may have been previously used to provide a “protective blanket” during the manufacture of solder and/or reclamation of solder dross. These uses would be on a static surface rather than where solder is flowing to make a joint or “tin” a surface. (It may be of interest to note that silicone oils are generally anathema around electronics manufacture because of difficulty of removing potentially harmful silicone oil residues.) Fatty acid monomers such as oleic acid, stearic acid, abietic acid, and resin acids have been used as solder flux.

### BRIEF SUMMARY OF THE INVENTION

An aspect of a soldering process involves maintaining a substantially continuous oxygen-barrier fluid layer on a surface of molten solder, contacting the solder with an oxygen scavenger, and contacting a surface to be soldered with the molten solder from beneath that layer.

### DESCRIPTION OF THE INVENTION

The description commences with an outline of an easily understood example of a soldering process with details and variations, as appropriate, added later. Thus, in its simplest form, a liquid oxygen-barrier layer is added to the molten solder in a wave soldering apparatus, for example. The liquid has a lower density and melting point than solder, and spreads across at least the exposed surface of the molten solder. Sufficient liquid is added to form at least a monomolecular film across the exposed surface. An oxygen scavenger is preferably added to the solder bath. A suitable scavenger has a higher (negative) free energy of formation of oxide than tin oxide so that tin oxide is chemically reduced. A printed circuit board is brought into contact with at least the surface of the molten solder so that solder wets metal surfaces and flows to fill plated-through holes, secure electrical leads, cover contact pads, etc.

Other aspects of the soldering process need not be described, such as, for example: application of flux to the PC board before soldering, use of a hot air knife or the like for removing excess solder, or any desired prior or subsequent cleaning considered desirable for such a PC board. Similar processes may be used for soldering non-electronic products, automobile radiators, for example.

A suitable liquid oxygen-barrier layer is an organic oil such as a fatty acid oil, e.g., monomers such as coconut oil, peanut oil, palm oil, olive oil, corn oil, safflower oil, tall oil, etc. Such oils may be blended for still further variations. Additional oxygen-barrier liquids include other vegetable oils, oleic acid, stearic acid, abietic acid, palmitic acid, linoleic acid, linolenic acid resin acids, and dimers, trimers and dendrimers of such oils, for example. The lower molecular weight materials are acceptable even though they may be smoky since the fumes and smoke can be removed from the area. Higher molecular weight materials are preferred since more stable. Substituted fatty acids (including dimers and trimers) are suitable, with end groups substituted for —COOH groups including amine, amide, thiol. A variety of higher melting paraffin waxes and waxes such as beeswax, and mixtures thereof may also form suitable oxygen-barrier liquids. Straight chain aliphatics are preferred, but aromatic materials are also acceptable.

When a dimer acid is used as an oxygen barrier layer, it has the additional advantage of assimilating metal oxide or dross that may form on the molten metal bath. A dimer acid is a high molecular weight di-carboxylic acid which is liquid, stable and resistant to high temperatures. It is produced by dimerization of unsaturated or saturated fatty acids at mid-molecule and often contains 36 carbons. Fatty acids are composed of a chain of aliphatic groups containing from 4 to as many as 30 carbon atoms and characterized by a terminal carboxyl group, —COOH. The generic formula for all carboxylic acids above acetic acid is CH₃(CH₂)ₓCOOH. The carbon atom count includes the —COOH group.

Fatty acids may be saturated or unsaturated. In some cases there may be dimers of mixed saturated and unsaturated fatty acids. Exemplary saturated fatty acids include palmitic acid (C16) and stearic acid (C18). Unsaturated fatty acids are usually vegetable-derived and comprise aliphatic chains usually containing 16, 18 or 20 carbon atoms with the characteristic end group —COOH. Among the most common unsaturated acids are oleic acid, linoleic acid and linolenic acid, all C18. Saturated fatty acids are preferred in practice of this invention. They are more stable at elevated temperature than unsaturated fatty acids with appreciable double bonds. Aromatic fatty acids are also known, for example phenyl-stearic, abietic acid and other fatty acids derived from rosin. Rosin acids comprise C20 monomers and may contain a phenanthrene ring (e.g. abietic and pimaric acids).

A particularly preferred oxygen-barrier liquid includes a heavy metal (e.g., tin) soap of a fatty acid monomer, dimer or trimer. Light metal soaps (e.g. sodium, lithium, calcium, magnesium) are also suitable. Such a soap can form a monomolecular film on the surface of the solder for effectively blocking access by oxygen. Polar liquids are preferred since they better “wet” the molten solder to maintain a continuous film or layer.

Other additives which may be suitable if they do not disassociate at the temperature of the molten solder comprise esters, anhydrides, imides, lactones and lactams. (For example, ERISYS GS-120, a glycidyl ester of linoleic acid dimer, available from Specialty Chemicals Inc. of Moorestown, N.J.) Thus, the oxygen-barrier liquid may comprise the hydrocarbon moiety of a dimer and/or trimer of fatty acid and at least one nucleophilic group on the hydrocarbon moiety. An appropriate additive is a difunctional organic molecule with a hydrocarbon moiety providing the capability of forming a monomolecular film on molten solder.

Low melting inorganic salts or salt mixtures may also serve as suitable oxygen barriers. Examples include sodium aluminum chloride (NaCl.AlCl₂ melting point 185° C.), sodium monofluroacetate, and mixtures of metal chlorides, fluorides and bromides. Divalent tin chloride (SnCl₂, melting point 246° C.) may be included in such mixtures for lowering melting point of the oxygen-barrier liquid.

The fluid oxygen-barrier layer may also be an inert gas such as nitrogen which blankets the surface. Nitrogen has been tried over soldering processes for minimizing dross formation. There has been limited success, probably because oxygen becomes mixed with the nitrogen as it is released adjacent to the solder. Better enclosures and higher flow rates of nitrogen may be used for obtaining a satisfactory oxygen-barrier of nitrogen, for example.

A second additive for the soldering process is an oxygen scavenger or deoxidizer for minimizing oxygen in the molten solder and reducing tin oxide and other metal oxides that may form. The most common species of tin oxide is apparently Sn₃O₄ and the oxygen scavenger should have a higher free energy of oxide formation (i.e., higher negative free energy) than the tin oxide to effectively reduce tin oxide. Most commonly, the scavenger is added to the body of molten tin or tin alloy.

Exemplary oxygen or metal oxide scavengers include calcium, magnesium, aluminum, lithium, potassium, sodium, titanium, zirconium, silicon, yttrium, rare earth metals and the like. Metal hydrides may also provide strong scavenging of oxides. These deoxidizers may be added to the solder directly or more preferably in the form of a tin alloy in a manner similar to addition of ferro-alloys to steel. Such alloys are preferred for rapid melting rather than slow dissolution in the solder. One may form pellets or a paste of oxygen-barrier material and scavenger additive powder for simultaneous automatic addition to the solder to replace depleted additives.

It is believed that oxygen in the molten solder is in the form of metal oxide, but ther may also be dissolved oxygen which is not stoichiometrically metal oxide. Thus, the scavenger is regarded as a scavenger of oxygen or metal oxide, regardless of the way oxygen is present in the molten metal.

Several oxygen barrier fluids and deoxidizers are mentioned as suitable. It will be recognized that some of these may not be suitable for electronics soldering applications for unrelated reasons (e.g., a residue may be hygroscopic). They may still be suitable for soldering processes for other applications such as dental products, automobile radiators, plumbing, etc.

Rather than a metal scavenging additive, one may immerse an electrode in the solder. The electrode may be a sacrificial one that is consumed, or it may be electrically connected for electrically reducing metal oxides at its surface without being consumed. One may bubble a liquid or gaseous deoxidizer through a solder bath for scavenging oxygen. For example, an 80% helium, 20% hydrogen mixture is a good deoxidizer. As mentioned, instead of a liquid oxygen-barrier, one may cover the surface of the solder with nitrogen or other inert gas. Thus, broadly, one uses a fluid oxygen barrier along with a separate deoxidizer or oxygen scavenger.

What is claimed is:

1. A soldering process comprising:
maintaining an oxygen barrier fluid on a surface of molten solder;
introducing an oxygen scavenger into the molten solder; and
contacting a surface to be soldered with the molten solder beneath that fluid.

2. A soldering process according to claim 1 wherein solder is withdrawn from beneath the fluid and flowed into conact with the surface to be soldered.

3. A soldering process according to claim 2 wherein the process is performed in wave soldering apparatus and the surface to be soldered is on a printed circuit board.

4. A soldering process according to claim 1 wherein the scavenger has a higher free energy of formation of oxide than the free energy of formation of tin oxide.

5. A soldering process according to claim 1 wherein the liquid oxygen-barrier fluid is an organic oil.

6. A soldering process according to claim 5 wherein the fatty acid oil is selected from the group consisting of monomers such as coconut oil, peanut oil, palm oil, olive oil, corn oil, safflower oil, tall oil; other vegetable oils such as oleic acid, stearic acid, abietic acid, palmitic acid, linoleic acid, linolenic acid, resin acids, and dimers, trimers and dendrimers of such oils; paraffin waxes; substituted fatty acids; and mixtures thereof.

7. A soldering process according to claim 1 wherein the liquid oxygen-barrier fluid is a straight chain aliphatic compound.

8. A soldering process according to claim 1 wherein the oxygen-barrier fluid includes a metal soap of a fatty acid monomer, dimer or trimer.

9. A soldering process according to claim 1 wherein the oxygen-barrier fluid comprises a polar liquid.

10. A soldering process according to claim 1 wherein the oxygen-barrier fluid comprises comprise esters, anhydrides, imides, lactones and lactams which do not disassociate at the temperature of the molten solder.

11. A soldering process according to claim 1 wherein the oxygen-barrier fluid comprises inorganic salts or salt mixtures which are molten at the temperature of molten solder.

12. A soldering process according to claim 11 wherein the inorganic salt also comprises divalent tin chloride.

13. A soldering process according to claim 1 wherein the oxygen-barrier fluid compises an inert gas.

14. A soldering process according to claim 1 wherein the oxygen scavenger is selected from the group consisting essentially of calcium, magnesium, aluminum, lithium, potassium, sodium, titanium, zirconium, silicon, yttrium, rare earth metals, metal hydrides and mixtures thereof.

15. A soldering process according to claim 1 wherein the oxygen scavenger compirses

16. A soldering process according to claim 1 wherein the oxygen scavenger compirses a liquid or gaseous deoxidizer bubbled through the solder bath.

17. A soldering process according to claim 1 wherein the object to be soldered is contacted with an area of the molten solder which does not include any visible additive.

18. A soldering process comprising:
maintaining a floating layer of an additive on a surface of molten lead-free solder in a wave, fountain or cascade soldering apparatus;
forming a dynamic flow of molten solder from the bath; and
soldering an object by contact of the object with a surface of the dynamic flow;
the layer of additive:
being liquid at the temperature of molten solder in the bath, and effectively barring oxygen in air from reaching a quiescent surface of the bath.
introducing a second additive to the bath, the second additive having the ability to effectively scavenge oxide of at least one metal from the bath,

19. A soldering process according to claim 18 wherein the molten solder is a lead-free solder.

20. A soldering process according to claim 18 wherein the molten solder is is at a temperature of no more than 260° C.

21. A soldering process according to claim 18 wherein the object to be soldered is contacted with an area of the molten solder which does not include any visible additive.

22. A soldering process comprising:
avoiding visible dross on a quiescent surface of molten solder by adding sufficient liquid additive to the surface to assimilate dross that may form;
scavenging oxygen or metal oxide from the bath; and
soldering an object with a dynamic surface of the molten solder.

23. A soldering process according to claim 22 wherein the liquid additive comprises a dimer acid.

24. A soldering process according to claim 23 wherein the scavenger has a higher free energy of formation of oxide than the free energy of formation of tin oxide.

25. A soldering process according to claim 22 wherein the molten solder is a lead-free solder.

26. Soldering apparatus containing a bath of molten solder comprising:
an oxygen barrier fluid over the surface of the molten solder;
a scavenger of oxygen or metal oxide in the molten solder bath; and
means for applying molten solder from the bath to an object to be soldered.

27. Soldering apparatus according to claim 26 wherein the solder is a lead-free solder and the temperature of the molten solder is no more than 260° C.

28. A solder joint made by bringing an object to be soldered in contact with molten solder in a bath of molten solder having an oxygen barrier fluid over a quiescent surface of the bath and a scavenger of oxygen or metal oxide in the bath.
